(19) United States
(12) Patent Application Publication
(10) Pub. No.: US 2025/0337079 A1
(43) Pub. Date: Oct. 30, 2025

(54) BATTERY CELL SUPPORT ASSEMBLY WITH INTEGRATED THERMAL EVENT MITIGATION

(71) Applicant: GM GLOBAL TECHNOLOGY OPERATIONS LLC, Detroit, MI (US)

(72) Inventors: Mohammad Hamza Kirmani, Troy, MI (US); Alireza Fatemi, Canton, MI (US); Anthony M. Coppola, Rochester Hills, MI (US); James D. Hendrickson, Oxford, MI (US); Matthew Kimball, Clarkston, MI (US); Thomas W. Nehl, Shelby Township, MI (US); David J. Brooks, Troy, MI (US)

(73) Assignee: GM GLOBAL TECHNOLOGY OPERATIONS LLC, Detroit, MI (US)

(21) Appl. No.: 18/645,982

(22) Filed: Apr. 25, 2024

(51) Int. Cl. H01M 50/249; H01M 10/04; H01M 10/48; H01M 50/293; H01M 50/367

(52) U.S. Cl. CPC H01M 50/249; H01M 10/482; H01M 10/486; H01M 50/293; H01M 50/367; H01M 10/04

(57) ABSTRACT

A multi-cell rechargeable energy storage system (RESS) includes battery cells with each of the battery cell having a respective cell vent configured to expel gases. A cell holder is configured to support the battery cells and includes a holder body defining apertures arranged in rows. Each aperture is configured to align with and be in fluid communication with the cell vent of one of the battery cells. Thermal event passageways are located adjacent the cell holder with each thermal event passageway extending parallel to a respective row of apertures. A potting material at least partially surrounding the battery cells and a sensor assembly is in each of the thermal event passageways.

### INTRODUCTION

The present disclosure relates to a battery cell support assembly with integrated thermal runaway mitigation for a multi-cell rechargeable energy storage system (RESS).

Typically, an electric energy generation and storage battery system includes one or more battery cells for powering a load. The battery cells may be arranged in close proximity to one another to generate a battery cell array or system, such as a battery module, pack, etc.

The battery cells may be used to store electrical energy for future use and as a buffer between peak power generation and peak system loads, such as in stationary energy storage systems and electric vehicles (EVs). Chemistries of rechargeable batteries, as well as external factors, may cause internal reaction rates generating significant amounts of thermal energy. Exposure of a battery cell to elevated temperatures over prolonged periods may cause the cell to experience a thermal event. Heat build-up in one cell may lead to the heat spreading or propagating to adjacent cells, thereby affecting the entire battery array.

### SUMMARY

Disclosed herein is a multi-cell rechargeable energy storage system (RESS). The RESS includes battery cells with each of the battery cell having a respective cell vent configured to expel gases. A cell holder is configured to support the battery cells and includes a holder body defining apertures arranged in rows. Each aperture is configured to align with and be in fluid communication with the cell vent of one of the battery cells. Thermal event passageways are located adjacent the cell holder with each thermal event passageway extending parallel to a respective row of apertures. A potting material at least partially surrounding the battery cells and a sensor assembly is in each of the thermal event passageways.

Another aspect of the disclosure may include an RESS enclosure having a tray and a mating cover with the RESS enclosure configured to house the battery cells, the cell holder, the potting material, and the sensor assembly.

Another aspect of the disclosure may be where the sensor assembly includes a dielectric sensor assembly.

Another aspect of the disclosure may be where the dielectric sensor assembly extend a length of each respective row of apertures.

Another aspect of the disclosure may be where the sensor assembly includes sensors aligned with a respective aperture.

Another aspect of the disclosure may be where the sensors include capacitive sensors.

Another aspect of the disclosure may be where the sensors include temperature sensors.

Another aspect of the disclosure may be where the sensor assembly includes at least one emitter and at least one receiver configured to receiver signals from the at least one emitter.

Another aspect of the disclosure may be where the at least one emitter is located adjacent to a first end of a respective one of the thermal event passageways and the at least one receiver is located adjacent a second end of the respective one of the thermal event passageways.

Another aspect of the disclosure may be where the emitter includes one of an infrared emitter, an ultrasonic emitter, or a laser beam emitter.

Another aspect of the disclosure may be where the sensor assembly is over molded with the cell holder.

Another aspect of the disclosure may be where the sensor assembly is attached to the cell holder with an adhesive.

Disclosed herein is a motor vehicle. The motor vehicle includes a power-source configured to generate power-source torque and a multi-cell rechargeable energy storage system (RESS) configured to supply electrical energy to the power-source. The RESS includes battery cells with each of the battery cell having a respective cell vent configured to expel gases. A cell holder is configured to support the battery cells and have a holder body defining apertures arranged in rows. Each aperture is configured to align with and be in fluid communication with the cell vent of one of the battery cells. Thermal event passageways are located adjacent the cell holder with each thermal event passageway extending parallel to a respective row of apertures. A potting material at least partially surrounding the battery cells and a sensor assembly is in each of the thermal event passageways.

Disclosed herein is a method of assembling a multi-cell rechargeable energy storage system (RESS). The method includes positioning battery cells adjacent to a cell holder configured to support the battery cells and having a holder body defining apertures arranged in rows. Each aperture is configured to align with and be in fluid communication with the cell vent of one of the battery cells. The method also includes positioning a sensor assembly within each of thermal event passageways with each of the thermal event passageways extending parallel to a respective row of apertures. The method also includes enclosing the battery cells with a RESS enclosure. The RESS enclosure includes a tray and a mating cover and is configured to house the battery cells, the cell holder, and the sensor assembly.

Another aspect of the disclosure may be where the sensor assembly includes sensors with each of the sensors aligned with a respective aperture.

Another aspect of the disclosure may be where the sensor assembly includes an emitter and a receiver configured to receiver signals from the emitter.

### BRIEF DESCRIPTION OF THE DRAWINGS

FIG. 1 is a schematic top view of an embodiment of a motor vehicle employing multiple power-sources and a multi-cell rechargeable energy storage system (RESS) configured to generate and store electrical energy used by vehicle systems including the power-sources.

FIG. 2 is a schematic side view of the RESS shown in FIG. 1, illustrating battery cells arranged inside a battery system enclosure having a tray and a cover.

FIG. 3 is a close-up schematic plan view of the RESS shown in FIG. 1, illustrating battery cells arranged in rows on a cell support assembly with thermal runaway mitigation, according to the present disclosure.

FIG. 4 is a cross-sectional view taken along line 4-4 of FIG. 3 illustrating an example sensor assembly within a passageway, according to the present disclosure.

FIG. 5 is a cross-sectional view taken along line 5-5 of FIG. 3 illustrating another example sensor assembly within a passageway, according to the present disclosure.

FIG. 6 is a cross-sectional view taken along line 6-6 of FIG. 3 illustrating yet another example sensor assembly within a passageway, according to the present disclosure.

FIG. 7 illustrates a method of detecting an intrusion into a passageway of the RESS of FIG. 1, according to the present disclosure.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

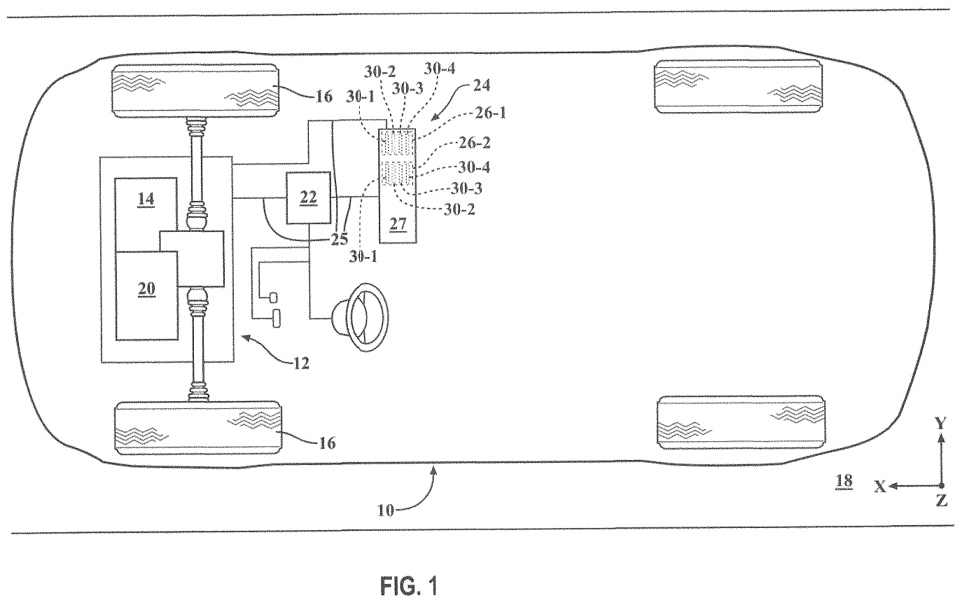

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque for propulsion of the vehicle 10 via driven wheels 16 relative to a road surface 18. The power-source 14 is depicted as an electric motor-generator.

As shown in FIG. 1, the powertrain 12 may also include an additional power-source 20, such as an internal combustion engine. The power-sources 14 and 20 may act in concert to power the vehicle 10. The vehicle 10 additionally includes an electronic controller 22 and a multi-cell rechargeable energy storage system (RESS) 24 configured to generate and store electrical energy through heat-producing electro-chemical reactions for supplying the electrical energy to the power-sources 14 and 20. The electronic controller 22 may be a central processing unit (CPU) that regulates various functions on the vehicle 10, or as a powertrain control module (PCM) configured to control the powertrain 12 to generate a predetermined amount of power-source torque. The RESS 24 may be connected to the power-sources 14 and 20, the electronic controller 22, as well as other vehicle systems via a high-voltage BUS 25.

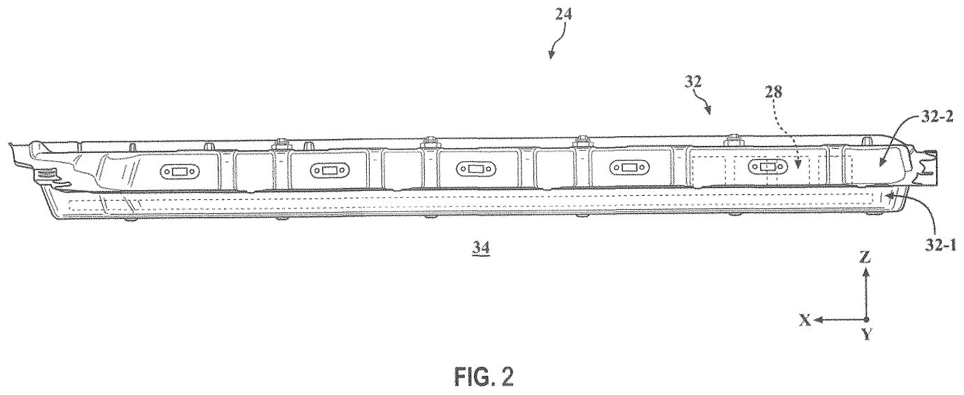

The RESS 24 includes a plurality of battery cells 28, which may be subdivided into battery groups or modules (shown as modules 26-1 and 26-2) and/or organized as a battery pack 27. As shown in FIG. 2, the battery cells 28 in each module of the RESS 24, such as the shown module 26-1 and module 26-2, are arranged in individual adjacent rows, such as a first row 30-1, a neighboring, directly adjacent, second row 30-2, as well as third and fourth rows 30-3 and 30-4. As shown, each battery cell 28 in rows 30-1, 30-2, 30-3, 30-4 may be configured as a cylindrical or a prismatic cell, extending generally upward in an X-Z plane. Although two modules, 26-1 and 26-2, with four rows 30-1, 30-2, 30-3, 30-4 of battery cells 28 in each module are shown, nothing precludes the RESS 24 from having a greater or fewer number of such modules and rows. The remainder of the present description will focus on module construction having four rows 30-1, 30-2, 30-3, 30-4 of battery cells 28, which may be adapted to a specific battery module having a desired overall quantity of cells.

As shown in FIG. 2, the RESS 24 also includes a battery pack or RESS enclosure 32 surrounded by an ambient environment 34, i.e., environment external to the RESS enclosure. The battery pack enclosure 32 is configured to house each row 30-1, 30-2, 30-3, 30-4 of the battery cells 28 in respective modules 26-1, 26-2 and includes an enclosure lower portion having an enclosure tray 32-1 and an upper portion having a mating enclosure cover 32-2 (shown in FIG. 2). The enclosure cover 32-2 is configured to engage the enclosure tray 32-1 to substantially seal the RESS enclosure 32 and its contents from the ambient environment 34. As shown, the RESS enclosure 32 is arranged in a horizontal X-Y plane, such that the enclosure cover 32-2 is positioned above the enclosure tray 32-1 when viewed along a Z-axis.

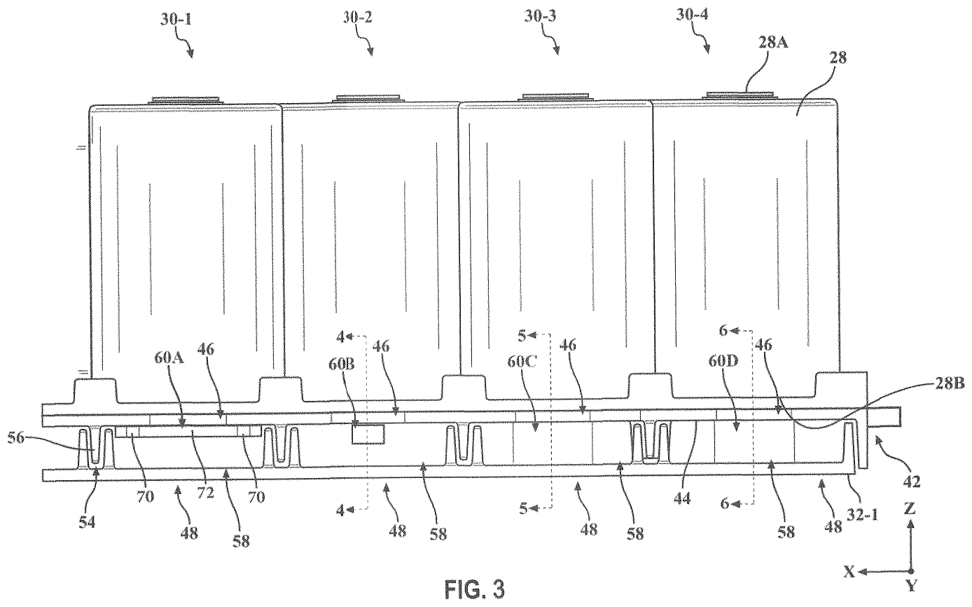

As shown in FIGS. 3-6, each battery cell 28 generally includes electrical terminal(s) 28A and respective cell vent(s) 28B configured to expel or vent high-pressure gases 36. Such gases 36 may be generated within the battery cell 28 as a byproduct of a thermal event in the battery cell 28.

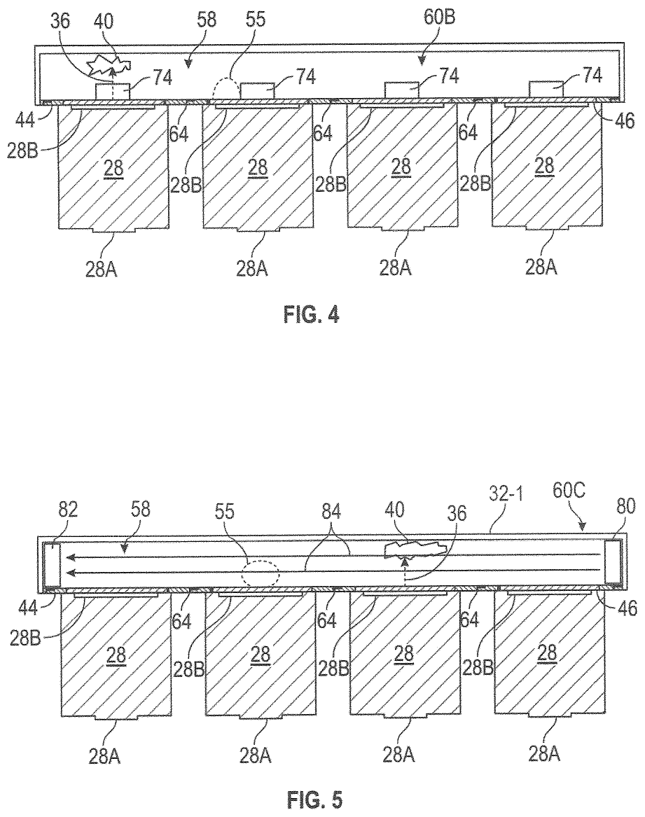

Generally, during normal operation of the RESS 24, cooling in the RESS 24 is effective in absorbing thermal energy released by the battery cells 28. However, during extreme conditions, such as during a thermal event (identified via numeral 40 in FIGS. 4-6), the amount of thermal energy released by the cell 28 undergoing the thermal event may exceed capacity of the RESS 24 to efficiently transfer heat, e.g., from the RESS enclosure 32 to the ambient environment 34. As a result, excess thermal energy will typically be transferred between the neighboring battery cells 28 and between neighboring cell modules 26, leading to propagation of thermal events through the RESS 24. The term “thermal event” generally refers to an uncontrolled temperature increase in one of the battery cells 28 that may propagate and spread through other battery cells 28 if not controlled. During a thermal event, the generation of heat within a battery system or a battery cell exceeds the dissipation of heat, thus leading to a further increase in temperature. A thermal event may be triggered by various conditions, including a short circuit within the cell, improper cell use, physical abuse, manufacturing defects, or exposure of the cell to extreme external temperatures.

For example, in the event one or more battery cells 28 in one cell module 26 experiences a thermal event 40, excess gases 36 generated during such an event would give rise to highly elevated internal cell pressures having tendency to break open the respective cell vent 28B. In the event of such gas venting, the expelled high-temperature gases 36 (with temperatures up to 1,500 degrees Celsius) may additionally send cell debris through the enclosure 32, triggering a thermal propagation of other neighboring battery cells 28 and cell modules 26. Accordingly, such transfer of high-temperature gases 36 typically increases the likelihood of a chain reaction affecting a significant part of the RESS 24.

As shown in FIGS. 3-6, the RESS 24 also includes a cell support assembly 42 with thermal event mitigation features arranged inside the enclosure 32. Although not shown, the enclosure 32 may additionally include a cell support structure arranged proximate the battery electrical terminals 28A for general stability of constituent battery cells 28. The cell support assembly 42 includes a cell holder 44 having a body portion configured to support, e.g., position and retain, the battery cells 28. The cell holder 44 may be constructed from a glass-filled nylon or another temperature resistant and tough material enabling a rigid and stable cell holder structure. The cell holder 44 includes a holder body defining a plurality of apertures 46 arranged in rows 48. When battery cells 28 are installed in the cell holder 44, the battery cell rows 30-1, 30-2, 30-3, 30-4 are arranged in and coincide with corresponding cell holder rows 48, such that each aperture 46 aligns with and is in fluid communication with the cell vent 28B of one of the constituent battery cells 28.

As shown in FIG. 3, the cell holder 44 may be configured to engage and fit together, such as slot in, with the enclosure tray 32-1. Specifically, as shown, the enclosure tray 32-1 may include multiple channels 54 and the cell holder 44 may include multiple integral projection or partition portions 56. Each cell holder projection portion 56 may be configured to engage one of the enclosure tray channels 54, thereby establishing a plurality of longitudinal thermal event passageways 58. Thus formed, each passageway 58 may extend along and below at least one of the rows 48 of apertures 46 (FIGS. 4-6) to direct the gases 36 expelled by corresponding battery cell(s) 28 positioned on the cell holder 44. The RESS 24 may additionally include an adhesive arranged inside the enclosure tray channel 54 between the enclosure tray 32-1 and the corresponding holder projection portion 56 to thereby fix the cell support assembly 42 to the enclosure tray.

During assembly of the RESS 24, a potting material 55 is inserted for surrounding the battery cells 28. In one example, the potting material 55 is inserted as a liquid material, such as a resin, that expands to fill voids between the battery cells 28 and the mating cover 32-2. As the potting material 55 expands within the RESS 24, air within the RESS 24 is displaced. To prevent the formation of regions in the RESS with high pressure air, the cell holder 44 includes air escape passageways 64 (FIGS. 4-5) that fluidly connect a first side of the cell holder 44 supporting the battery cells 28 to a second side of the cell holder 44 adjacent the passageways 58. In the illustrated example, the air escape passageways 64 follow a tortuous path having a series of straight sections connected by turns or bends. The air escape passageways 64 can be formed through a series of overlap joints in plastic features and a sheet of mica such that the mica acts as a thermal event barrier. The air escape passageways 64 are also located between adjacent cells 28 and are in fluid communication with the passageways 58 to utilize the passageways 58 for the purposes of allowing the displaced air to escape the RESS 24 during assembly.

As shown in FIG. 4, each of the passageways 58 may also include a sensor assembly, such as at least one of sensor assemblies 60A, 60B, 60C, or 60D. While the illustrated example shows four different sensor assemblies in the RESS 24, the RESS 24 can includes a single type of sensor assembly for each of the passageways 58 or different sensor assemblies between the separate passageways 58. The sensor assemblies 60A, 60B, 60C, and 60D aid in detecting a thermal event in an individual cell 28 or row 30 of cells 28 in the RESS 24 as described in greater detail below. Additionally, the sensor assemblies 60A, 60B, 60C, and 60D can detect the presence of material, such as the potting material 55, protruding into the passageway 58 as discussed in greater detail below. The sensor assemblies 60A, 60B, 60C, and 60D can be over molded with the cell holder 44, attached to the cell holder 44 with an adhesive, or heat staked to the cell holder 44.

As shown in FIG. 3, the sensor assembly 60A includes a dielectric sensor assembly having a pair of electrodes 70 supported in a substrate material 72. During operation of the sensor assembly 60A, each of the electrodes 70 are operated at a different voltages to create a non-uniform electric field. When the potting material 55 is installed into the RESS 24, the potting material 55 may expand into areas of the RESS 24 beyond the region surrounding the cells 28, such as into the passageway 58. If the potting material 55 expands into the passageway 58, it will interact with the electric field generated by the electrodes 70. This interaction can result in circuitry of the sensor assembly 60A detecting a change in capacitance. When a change in capacitance is detected by the sensor assembly 60A, an alert can be triggered to indicate a possible intrusion of the potting material 55 into the passageway 58. The potting material 55 can then be removed from the passageway 58 if it blocks the passageway 58 beyond a predetermined cross-sectional area of the passageway 58.

As shown in FIGS. 3-4, one of the passageways 58 in the RESS 24 can also include the sensor assembly 60B. One feature of the sensor assembly 60B, is that a sensor 74 is associated with each individual cell 28 and is located adjacent to a corresponding aperture 46 in the cell holder 44. This allows the sensor assembly 60B to identify the presence of potting material 55 or a thermal event 40 with accuracy down to an individual one of the cells 28. The sensors 74 can include one or more of a capacitive sensor, a temperature sensor, a pair of electrodes, a current leakage sensor, or a liquid sensor adjacent to each of the apertures 46.

When sensor 74 includes a capacitive sensor, the sensor assembly 60B is able to identify both the presence of potting material 55 in the passageway 58 and a thermal event 40 occurring in an individual cell 28. The sensor 74 can include two electrodes that are separated from each other by a dialectic material, such as air or a dielectric substrate. When an object or material approaches or comes into contact with this type of sensor 74, it alters the dielectric properties between the electrodes causing a change in capacitance. Circuitry of the sensor assembly 60B can measure the change in capacitance by monitoring current flowing through one of the electrodes or by observing a change in the alternating current flowing therethrough. The change in capacitance can trigger an alert that the potting material 55 may have entered the passageway 58 if detected after installation of the potting material 55 into the RESS 24.

Furthermore, if the change in capacitance determined by the sensor assembly 60B occurs during the use of the RESS 24, this can indicate that a thermal event 40 has occurred within a corresponding one of the cells 28. The thermal event 40 can be detected by the gases 36 leaving the cell 28 and entering the passageway 58 through the aperture 46 or by other debris from within the cell 28 entering the passageway 58 adjacent the sensor 74.

When the sensor 74 includes a temperature sensor, the sensor assembly 60B is able to identify both the presence of potting material 55 in the passageway 58 and a thermal event 40 occurring in an individual cell 28. When the potting material 55 is being installed in the RESS 24, it produces an exothermic reaction while it expands and cures. If the potting material 55 reaches within a predetermined distance of one of the temperature sensor, the sensor assembly 60B can trigger an alert that the potting material 55 may have entered the passageway 58.

Furthermore, the temperature sensor in the sensor assembly 60B can identify a thermal event 40 by measuring changes in temperature within the passageway 58. If a change has been determined that exceeds a predetermined threshold it can indicate that the corresponding cell 28 has experienced a thermal event 40. This is due to the extreme temperature of the gases 36 that leave the cell 28 as discussed above.

When the sensor 74 includes a pair of electrodes, the sensor assembly 60B is able to identify both the presence of potting material 55 in the passageway 58 and a thermal event 40 occurring in an individual cell 28. The sensor 74 can include a pair of electrodes that sense leakage current between them resulting from a conductivity of the potting material 55 in close proximity to the electrodes. The sensor assembly 60B can trigger an alert to the possibility of the potting material 55 intruding into the passageways 58. Similarly, the pair of electrodes can sense the gases 36 or debris from within the cell 28 entering the passageway during a thermal event 40 and the sensor assembly 60B can trigger an alert for a possible thermal event 40.

For the example of the sensor 74 including a liquid sensor, the sensor assembly 60B can identify both the presence of potting material 55 in the passageway 58 and a thermal event 40 occurring in an individual cell 28. The sensor 74 can include a liquid absorbing film that can swell in the presence of liquid causing an electrical response that can be detected by the sensor assembly 60B. If the liquid is detected when potting material 55 is being installed into the RESS 24, it can indicate that the potting material 55 has intruded into the passageway 58 and trigger an alert. Similarly, the liquid sensor can detect the presence of liquids expelled from the cell 28 during a thermal event 40 and the sensor assembly 60B can trigger an alert for a possible thermal event 40.

As shown in FIGS. 3 and 5, the sensor assembly 60C can identify both the presence of potting material 55 in the passageway 58 and a thermal event 40 occurring within a row of cells 28. In the illustrated example, the sensor assembly 60C includes an emitter 80 that generates an electromagnetic radiation, such as an infrared light, ultrasound waves, or laser beams, that are detected by a receiver 82 that is configured to detect the corresponding type of electromagnetic radiation. In the illustrated example, the emitter 80 is located at a first end of the passageway 58 and the receiver 82 is located at a second opposite end of the passageway 58 such that the electromagnetic radiation will pass over each of the apertures 46 in the row 30 of cells 28. Because the sensor assembly 60C views an entire row 30 of cells 28 at a given time, the sensor assembly 60C can identify events that occur over an entire row 30 of cells 28.

For example, the receiver 82 can sense a break in the electromagnetic radiation 84 from the emitter 80. This break in the electromagnetic radiation 84 can indicate that the potting material 55 has entered the passageway 58 if detected during installation of the potting material 55 into the RESS 24 and the sensor assembly 60C can trigger an alert. Similarly, if the sensor assembly 60C detects a break in the electromagnetic radiation 85 received by the receiver 82 during operation of the RESS 24, it can indicate the presence of gases 36 or debris entering the passageway 58 during a thermal event 40 and trigger a corresponding alert.

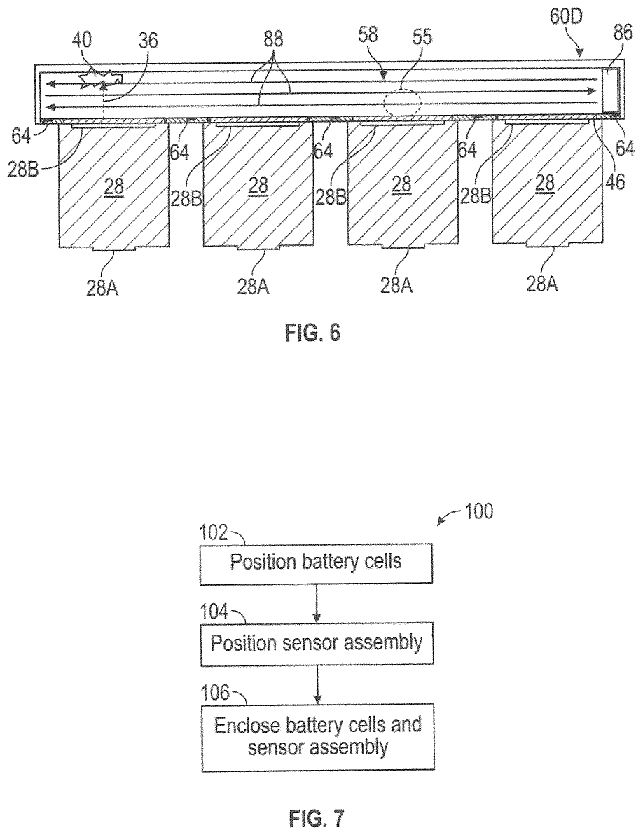

As shown in FIGS. 3 and 6, the sensor assembly 60D can identify both the presence of potting material 55 in the passageway 58 and a thermal event 40 occurring within a row of cells 28. In the illustrated example, the sensor assembly 60D includes a combination emitter/receiver 86 that both generates an electromagnetic radiation 88, such as an infrared light, ultrasound waves, or laser beams, and detects the electromagnetic radiation 88 that has reflected in the passageway 58 back towards the combination emitter/receiver 86. In the illustrated example, the combination emitter/receiver 86 is located at a first end of the passageway 58 and can emit the electromagnetic radiation 88 down the passageway 58 and over each of the apertures 46 in the row 30 of cells 28. Because the sensor assembly 60D views an entire row 30 of cells 28 at a given time, the sensor assembly 60C can identify events that occur over an entire row 30.

For example, the combination transmitter/receiver 86 can sense a change in the electromagnetic radiation 88 that is reflected and receiver. This change in the electromagnetic radiation 88 being receiver can indicate that the potting material 55 has entered the passageway 58 if detected during installation of the potting material 55 into the RESS 24 and the sensor assembly 60D can trigger an alert. Similarly, if the sensor assembly 60D detects the change in electromagnetic radiation 88 during operation of the RESS 24, it can indicate the presence of gases 36 or debris entering the passageway 58 during a thermal event 40 and trigger an alert.

FIG. 7 illustrates an example method 100 of assembling the RESS 24. The method 100 begins at Block 102 by positioning the battery cells 28 adjacent to the cell holder 44 for supporting the battery cells 28. The battery cells 28 are arranged relative to the cell holder 44 such that a body of the cell holder 44 defining the rows of apertures 46 are in fluid communication with the cell vent 28B of a corresponding one of the of battery cells 28. The cell vent 28B is in fluid communication with the passageway 58 through the apertures 46 in the cell holder 44.

The method then proceeds to Block 104 and positions one of the sensor assemblies 60A, 60B, 60C, or 60D within each of the thermal event passageways 58. Each of the thermal event passageways 58 extend parallel to a respective row of apertures 46 in the cell holder 44 to allow the venting of gases 36 from the RESS 24.

The method 100 then proceeds to Block 106 and encloses the battery cells 28 within the RESS enclosure 32. In one example, the RESS enclosure 32 includes the tray 32-1 and the mating cover 32-2 and is configured to house the battery cells 28, the cell holder 44, and the sensor assembly 60A, 60B, 60C, or 60D. Once the RESS enclosure 32 is complete, the potting material can be inserted into the RESS 24 and allowed to expand and cure. During this installation process, the sensor assemblies 60A, 60B, 60C, or 60D can identify the presence of potting material 55 as discussed in greater detail above.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claims is:

1. A multi-cell rechargeable energy storage system (RESS) comprising:
a plurality of battery cells, wherein each battery cell includes a respective cell vent configured to expel gases;
a cell holder configured to support the plurality of battery cells and having a holder body defining a plurality of apertures arranged in rows, wherein each aperture is configured to align and be in fluid communication with the cell vent of one of the plurality of battery cells;
a plurality of thermal event passageways located adjacent the cell holder, wherein each thermal event passageway extends parallel to a respective row of apertures of the plurality of apertures;
a potting material at least partially surrounding the plurality of battery cells; and
a sensor assembly located in each of the plurality of thermal event passageways.

2. The multi-cell RESS of claim 1, including an RESS enclosure having a tray and a mating cover, wherein the RESS enclosure is configured to house the plurality of battery cells, the cell holder, the potting material, and the sensor assembly.

3. The multi-cell RESS of claim 1, wherein the sensor assembly includes a dielectric sensor assembly.

4. The multi-cell RESS of claim 3, wherein the dielectric sensor assembly extends a length of each respective row of apertures of the plurality of apertures.

5. The multi-cell RESS of claim 1, wherein the sensor assembly includes a plurality of sensors with each of the plurality of sensors aligned with a respective aperture of the plurality of apertures.

6. The multi-cell RESS of claim 5, wherein the plurality of sensors includes a plurality of capacitive sensors.

7. The multi-cell RESS of claim 5, wherein the plurality of sensors includes a plurality of temperature sensors.

8. The multi-cell RESS of claim 1, wherein the sensor assembly includes at least one emitter and at least one receiver configured to receiver signals from the at least one emitter.

9. The multi-cell RESS of claim 8, wherein the at least one emitter is located adjacent to a first end of a respective one of the plurality of thermal event passageways and the at least one receiver is located adjacent a second end of the respective one of the plurality of thermal event passageways.

10. The multi-cell RESS of claim 9, wherein the emitter includes one of an infrared emitter, an ultrasonic emitter, or a laser beam emitter.

11. The multi-cell RESS of claim 1, wherein the sensor assembly is over molded with the cell holder.

12. The multi-cell RESS of claim 1, wherein the sensor assembly is attached to the cell holder with an adhesive.

13. A motor vehicle comprising:
a power-source configured to generate power-source torque; and
a multi-cell rechargeable energy storage system (RESS) configured to supply electrical energy to the power-source, the RESS including:
a plurality of battery cells, wherein each battery cell includes a respective cell vent configured to expel gases;
a cell holder configured to support the plurality of battery cells and having a holder body defining a plurality of apertures arranged in rows, wherein each aperture is configured to align and be in fluid communication with the cell vent of one of the plurality of battery cells;
a plurality of thermal event passageways located adjacent the cell holder, wherein each thermal event passageway extends parallel to a respective row of apertures of the plurality of apertures;
a potting material at least partially surrounding the plurality of battery cells; and
a sensor assembly located in each of the plurality of thermal event passageways.

14. The motor vehicle of claim 13, including an RESS enclosure having a tray and a mating cover, wherein the RESS enclosure is configured to house the plurality of battery cells, the cell holder, the potting material, and the sensor assembly.

15. The motor vehicle of claim 13, wherein the sensor assembly includes a dielectric sensor assembly extending a length of each respective row of apertures of the plurality of apertures.

16. The motor vehicle of claim 13, wherein the sensor assembly includes a plurality of sensors with each of the plurality of sensors aligned with a respective aperture of the plurality of apertures.

17. The motor vehicle of claim 13, wherein the sensor assembly includes at least one emitter and at least one receiver configured to receiver signals from the at least one emitter.

18. A method of assembling a multi-cell rechargeable energy storage system (RESS), the method comprising:
positioning a plurality of battery cells adjacent to a cell holder configured to support the plurality of battery cells and having a holder body defining a plurality of apertures arranged in rows, wherein each aperture is configured to align and be in fluid communication with the cell vent of one of the plurality of battery cells;
positioning a sensor assembly within each of a plurality of thermal event passageways, wherein each of the plurality of thermal event passageways extend parallel to a respective row of apertures of the plurality of apertures; and
enclosing the plurality of battery cells with a RESS enclosure, the RESS enclosure including a tray and a mating cover, wherein the RESS enclosure is configured to house the plurality of battery cells, the cell holder, and the sensor assembly.

19. The method of claim 18, wherein the sensor assembly includes a plurality of sensors with each of the plurality of sensors aligned with a respective aperture of the plurality of apertures.

20. The method of claim 19, wherein the sensor assembly includes an emitter and a receiver configured to receiver signals from the emitter.
